(19) United States
(12) Patent Application Publication
(10) Pub. No.: US 2015/0205504 A1
(43) Pub. Date: Jul. 23, 2015

(54) Configuring the Navigation Model in a Mobile Device

(71) Applicant: Rupen Chanda, San Francisco, CA (US)

(72) Inventor: Rupen Chanda, San Francisco, CA (US)

(73) Assignee: Adobe Systems Incorporated

(21) Appl. No.: 12/039,430

(22) Filed: Feb. 28, 2008

(51) Int. Cl. G06F 3/0484; G06F 15/177

(52) U.S. Cl. CPC G06F 3/04847; G06F 3/04842

(57) ABSTRACT

The present disclosure includes, among other things, systems, methods and program products for configuring the navigation model in a mobile device.

### BACKGROUND

Users typically utilize a wide variety of applications and perform many functions on mobile devices such as mobile phones. FIG. 1 shows a smart phone 100, which is one example of a mobile device. The smart phone 100 has a display 102 and various physical input devices. Physical input devices allow users to operate and enter data into the smart phone 100. In this illustration, the input devices include a power on/off key 102, a call hold key 104, a miniature QWERTY keyboard 106, special keys 108, a track ball or mouse pad 110, and a scroll wheel 112. The display 102 can be touch sensitive and thus also act as an input device for touch and gesture input.

Applications for mobile devices are programmed to perform certain actions based on predefined sequences of input from physical input devices. Sometimes, however, it is desirable to change how an application reacts to such input. For example, it might be desirable to cause the scroll wheel 112 to magnify text rather than scroll text in a text messaging application. Modifying how a program reacts to input from physical input devices can require downloading a new version of the program to the mobile device which can be costly and time consuming.

### SUMMARY

In general, one or more aspects of the subject matter described in this specification can be embodied in one or more methods that include identifying an initial navigation configuration for a mobile device. The initial navigation configuration specifies a mapping between one or more physical input devices on the mobile device and a plurality of virtual input devices for navigation of a user interface for one or more applications resident on the mobile device. A new navigation configuration for the mobile device is received. The new navigation configuration replaces the initial navigation configuration, and the new navigation configuration specifies a mapping between one or more of the plurality of physical input devices on the mobile device and one or more of the plurality of virtual input devices. Input from a first physical input device on the mobile device is received. A virtual input device is selected based on the input, the first physical input device, and the new navigation configuration. One of the applications on the mobile device is notified based on the input and the selected virtual input device. Other embodiments of this aspect include corresponding systems, apparatus, and computer program products.

These and other embodiments can optionally include one or more of the following features. Whether the new navigation configuration specifies a mapping between the first physical input device and a virtual input device is determined, and if so, the specified virtual input device is selected, and if not, a virtual input device from a default navigation configuration is selected. The navigation configuration can include a plurality of name and value pairs, where each name specifies a physical input device and a state of the mobile device, and where each value specifies a virtual input device that is mapped to the associated physical input device and state of the mobile device. A virtual input device can be selected based on a state of the mobile device. The state of the mobile device can include a screen state and an application mode.

In general, one or more aspects of the subject matter described in this specification can be embodied in one or more methods that include establishing an initial navigation configuration for a mobile device. The initial navigation configuration specifies a mapping between one or more physical input devices on the mobile device and a plurality of virtual input devices for navigation of a user interface for one or more applications resident on the mobile device. A plurality of compatible mobile devices is identified. Each of the plurality of compatible mobile devices is operable to receive a navigation configuration and adopt a navigation model according to the navigation configuration. The initial navigation configuration is sent to each of the identified compatible mobile devices. A new navigation configuration for the mobile device is established. The new navigation configuration specifies a mapping between one or more of the plurality of physical input devices on the mobile device and one or more of the plurality of virtual input devices. The new navigation configuration is sent to one or more of the identified compatible mobile devices.

These and other embodiments can optionally include one or more of the following features. The new navigation configuration can include a plurality of name and value pairs, where each name specifies a physical input device and a state of the mobile device, and where each value specifies a virtual input device that is mapped to the associated physical input device and state of the mobile device. An indication is received from each of the one or more of the identified compatible mobile devices of whether the identified compatible mobile device successfully adopted a new navigation model according to the new navigation configuration.

Particular embodiments of the invention can be implemented to realize one or more of the following advantages. The navigation model of a mobile device can be dynamically updated and customized without requiring new software on the mobile device. The navigation model can be updated over a wireless network. Navigation configuration files are small enough to be sent over a wireless network in a reasonable amount of time. Mobile device operators can maintain and update different navigation models for mobile devices with different configurations, including physical input devices.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example smart phone.

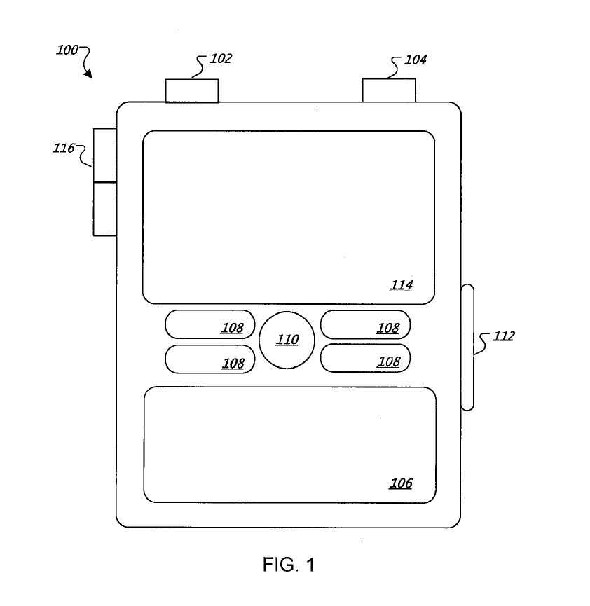

FIG. 2 is a flowchart of an example technique for adopting a new navigation model.

FIG. 3 is a flowchart of an example technique for remotely updating the navigation model of one or more mobile devices.

FIGS. 4A and 4B illustrate an example navigation configuration.

FIG. 5 shows an example system including servers and mobile devices.

FIG. 6 is a block diagram of computing devices.

Like reference numbers and designations in the various drawings indicate like elements.

### DETAILED DESCRIPTION

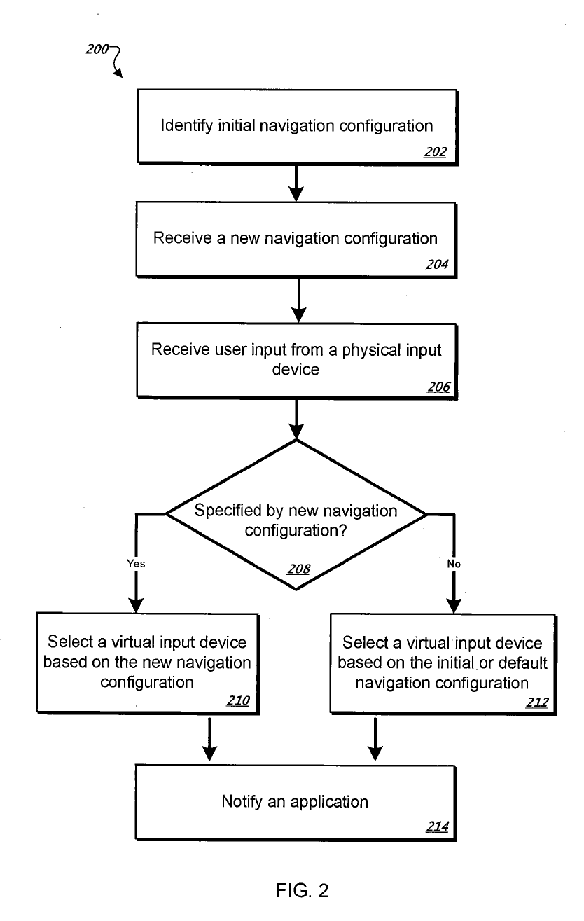

FIG. 2 is a flowchart of an example method 200 for adopting a new navigation model. For convenience, the method 200 will be described with respect to a mobile device (e.g., smart phone 100, computing device 650, or the like) that performs the method.

The mobile device identifies an initial navigation configuration (step 202). The initial navigation configuration specifies a mapping between one or more physical input devices on the mobile device and a plurality of virtual input devices. In some implementations, the mobile device also identifies a default navigation configuration.

The physical input devices are mapped to functionality on the mobile device. In some cases, a physical input device is permanently mapped to a certain function; in other cases, each physical input device can be mapped to different functions at different times. For example, a “clear” key (e.g., one of 108) can return a user to a previous screen (or a home screen) when pressed. Physical input devices mapped in this sense can be described as being mapped to abstract or virtual devices.

A virtual input device specifies a function or a group of functions. In the example regarding the clear key, the physical clear key is mapped to a virtual “return” or “go back” key that is associated with the function of returning a user to a previous screen. Examples of virtual input devices include the following virtual keys: a key for going down to the next content channel (e.g., news, sports, music), a key for going up to the previous channel, a key for the cancel button of a dialog, a key for the OK button of dialog, a key for exiting the current application, a key for going to the home screen, and so on.

A navigation model is a model that describes, in general, how a user interacts with a mobile device. A navigation model is based on a group of mappings between physical input devices and functionalities of the mobile device. A navigation configuration can specify a navigation model by specifying mappings. Mobile device operators can select the mappings to present an intuitive and efficient navigation model and user interface.

Examples of navigation models include “carousel” and “hub-and-spoke.” In the carousel navigation model, pressing “left” or “right” physical keys on a mobile device switches the channel displayed on the device and optionally displays a scrolling transition effect. In this case the physical left and right keys of the mobile device are mapped to “ChannelUp” and “ChannelDown” functionality (i.e., ChannelUp and ChannelDown virtual keys). In the hub-and-spoke navigation model, users can select new channels while the mobile device is showing a “now playing” channel, and then return to the now playing channel by pressing a physical key that is mapped to “Back” functionality (i.e., a Back virtual key). The left and right keys are not mapped to ChannelUp and ChannelDown as in the carousel model; instead, the left and right keys have different functionality depending on the now playing content.

Referring to FIG. 2 (step 202), in some implementations, the mobile device identifies the initial navigation configuration as a navigation configuration resident on the mobile device. For example, the initial navigation configuration can be installed on the mobile device when it is manufactured, either in a file or part of a file, or hard coded into software resident on the device. In other implementations, the mobile device receives the initial navigation configuration over a network (e.g., wireless, wired, hybrid, or combination of these, or the like). For example, the mobile device can receive the initial navigation configuration when it is first activated.

The mobile device receives a new navigation configuration (step 204). Typically, the mobile device receives the new navigation configuration over a network (e.g., wireless, wired, hybrid, or combination of these, or the like). The new navigation configuration replaces or supersedes the initial navigation configuration. Like the initial navigation configuration, the new navigation configuration specifies a mapping between one or more physical input devices and a plurality of virtual input devices. However, the new navigation configuration can specify an entirely different navigation model. For example, the initial navigation configuration can specify a carousel navigation model, and then the new navigation configuration can specify a hub-and-spoke navigation model or a customized navigation model.

The mobile device receives input from a physical input device (step 206). For example, a user may press a key (e.g., one of 108), or roll a scroll wheel e.g. 112, or make a gesture on a touch pad e.g. 102.

The mobile device selects a virtual input device based on the input, the physical input device, and either the new navigation configuration or the default navigation configuration. In some implementations, the mobile device selects the virtual input device additionally based on a state of the mobile device. The mobile device determines whether the new navigation configuration specifies a mapping between the physical input device and a virtual input device (step 208). If it does, then the mobile device selects the specified virtual input device (step 210). If it does not, then mobile device selects a virtual input device from a default navigation configuration (step 212).

In some implementations, the mobile device software includes a key manager class that facilitates selection of virtual input devices. In such cases, when the mobile device receives input from a physical input device, the key manager uses a navigation configuration to select a virtual input device. The key manager searches the navigation configuration (which, for example, is stored as a file or part of a file, or loaded into memory) for an entry for the physical input device and current state of the mobile device and then determines the corresponding virtual input device.

The state of the mobile device is based on one or more of several factors, for example, what applications are running, what operations the mobile device is performing, what content is displayed on the display device, whether a cellular or local wireless internet connection is available, and so on. In some implementations, the state of the mobile device is characterized by both an application mode and a screen state. The application mode specifies whether an application is running and if so what kind of application it is. Examples of application modes include: external standalone application mode, home screen mode, internal standalone application mode, portal application mode, and so on. The screen state is based on what the mobile device is showing on a display device. Examples of screen states include: a state when a dialog box is on screen, a normal state with content being shown, a state with an initialization screen being shown, a state with a preference screen being shown, and so on.

The mobile device notifies one of the applications based on the user input and the selected virtual input device (step 214). For example, suppose the mobile device is displaying a news application and a user presses a “left” key, and based on the navigation configuration the mobile device selects a virtual key for going to the previous news story. In that case, the mobile device can notify the news application that a user has pressed the virtual key for going to the previous story. For an additional example, suppose the user scrolled a physical scroll wheel upwards three clicks, and the mobile device selects a virtual scroll wheel for moving up or down lines of text. In that case, the mobile device can notify the news application that a user has scrolled the virtual scroll wheel upwards for three lines of text.

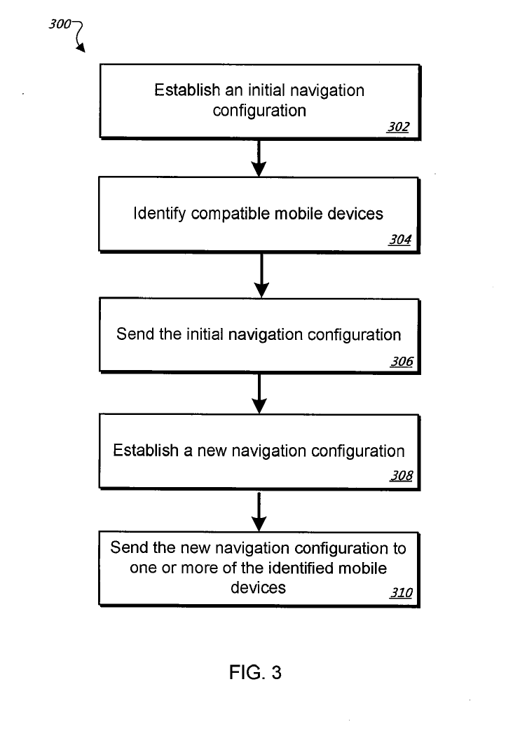

FIG. 3 is a flowchart of an example method 300 for remotely updating the navigation model of one or more mobile devices. For convenience, the method will be described with respect to a system (e.g., computing device 600, server 502, or the like) that performs the method. The system establishes an initial navigation configuration (step 302). In general, a system operator specifies the mappings within the initial navigation configuration. In some implementations, the system selects the initial navigation configuration from several navigation configurations in storage. In other implementations, a system operator creates the initial navigation configuration and makes it accessible to the system.

The system identifies a set of compatible mobile devices (step 304). In some implementations, a compatible mobile device is a mobile device having the physical input devices specified by the initial navigation configuration. In other implementations, a compatible mobile device is a mobile device having a certain set of applications, or a mobile device associated with a certain kind of user or user account, or a mobile device specified by a system operator. In further implementations, a compatible mobile device matches another set of criteria. Each mobile device is operable to receive a navigation configuration over a wireless network and adopt a navigation model according to the navigation configuration.

In some implementations, the system identifies compatible mobile devices using a table of mobile devices and their physical input devices, account information, resident application information, and the like. In other implementations, the system queries mobile devices over a wireless network to determine whether they are compatible. In further implementations, a system operator specifies specific mobile devices or groups of mobile devices.

The system sends the initial navigation configuration (step 306). In general, the system sends the initial navigation configuration over a network (e.g., wireless, wired, hybrid, or combination of these, or the like). The system sends the initial navigation configuration to the identified compatible mobile devices. Typically, the mobile devices adopt a navigation model according to the initial navigation configuration. In some implementations, the system queries the mobile devices (or automatically receives feedback from the mobile devices) to determine whether they successfully adopted a new navigation model. In those implementations, the system can compile a list of successful and unsuccessful mobile devices and optionally alert a system operator.

The system establishes a new navigation configuration (step 308). The new navigation configuration is distinct from the initial navigation configuration and can specify a new navigation model.

The system sends the new navigation configuration to one or more of the identified compatible mobile devices (step 310). In some implementations, the system sends the new navigation configuration to all of the identified mobile devices. In other implementations, the system sends the new navigation configuration only to identified mobile devices that meet additional criteria (e.g., regarding those mobile devices' owners, owners' accounts, cellular provider, and so on). In other implementations, the system sends the new navigation configuration to mobile devices specified by a system operator.

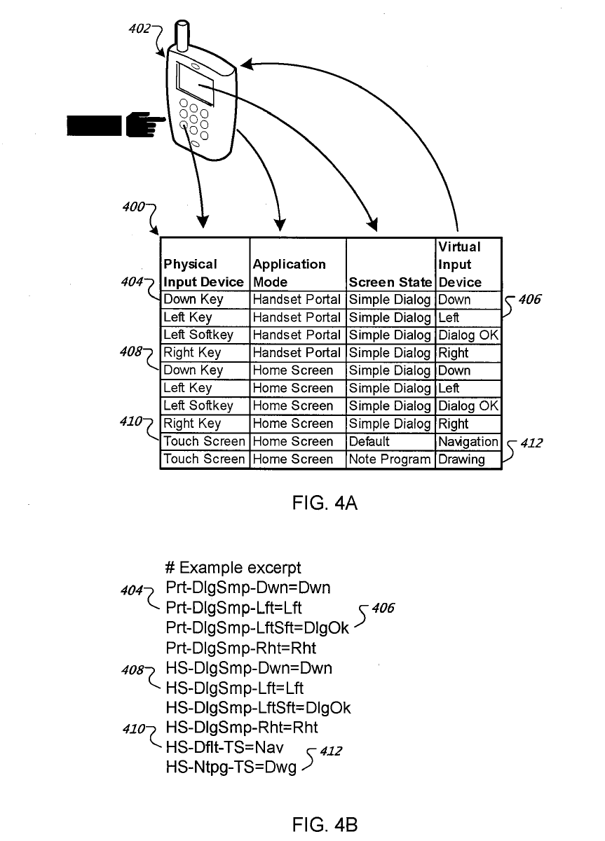

FIGS. 4A and 4B illustrate an example navigation configuration. In general, a navigation configuration is an electronic document. An electronic document does not necessarily correspond to a file. A document may be stored in a portion of a file that holds other documents, in a single file dedicated to the document in question, in multiple coordinated files, or in memory without first having been stored in a file.

FIG. 4A shows an example navigation configuration represented by a table 400. A mobile device 402 uses the navigation configuration to map physical input devices to virtual input devices. For example, suppose a user presses a “down” key while the mobile device is running a “handset portal” application and displaying a simple dialog box corresponding to a screen state of “simple dialog.” The mobile device can find the row 404 in the table 400 corresponding to the physical input device (the down key), the application mode (handset portal), and the screen state (simple dialog). Then the mobile device can determine the corresponding virtual input device (down).

Similarly, if the user presses a “left” key, the mobile device can find the corresponding row 406 and determine the corresponding virtual input device (left). Furthermore, if the application mode is different, for example if the user returns to the home screen (and the mobile device's application mode changes to “home screen”), the mobile device can again find the corresponding row 408 and determine the corresponding virtual device (left).

In various implementations, a navigation configuration specifies mappings for various kinds of physical input devices. For example, in the example navigation configuration in FIG. 4A, a mapping is shown for a touch screen physical input device on rows 410 and 412. If a user makes a gesture on a touch screen while the application mode is “home screen” and the screen state is “default” as in row 410, the input is mapped to a navigation function, so that the gesture moves a cursor or a view. If a user makes a gesture on a touch screen while the screen state is “note program” as in row 412, the input is mapped to a drawing function, so that the gesture draws lines on the screen.

In this example, the mappings are based on an optional state of the mobile device, and the state of the mobile device is characterized by an application mode and a screen state. Alternatively, the mappings are not based on a state of the mobile device, or are based on other factors.

A navigation configuration can be specified in files of various formats. In some implementations, a navigation configuration is specified by name and value pairs. FIG. 4B shows the example navigation configuration of FIG. 4A represented by name and value pairs. For example, in the line corresponding to the first row 404 of the table 400 of FIG. 4A, the name is “Prt-DlgSmp-Dwn” and the value is “Dwn.” The name is shorthand for the application mode (handset portal), the screen state (simple dialog), and the physical input device (down). Similarly, the value is shorthand for down. In further implementations, the navigation configuration is an XML document, other markup document, or the like.

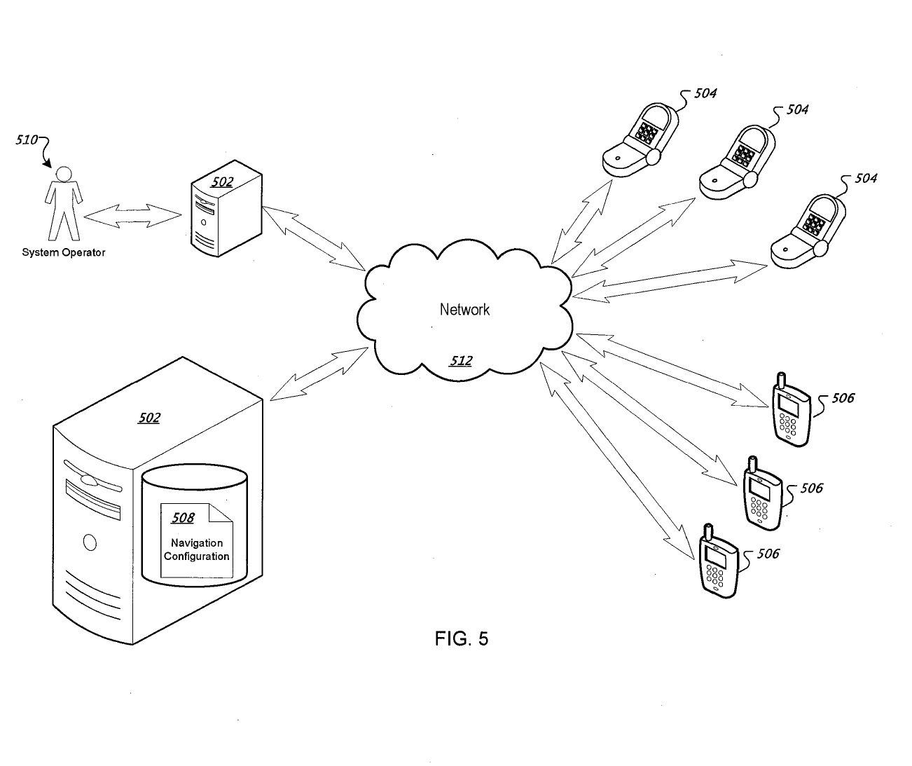

FIG. 5 shows an example system including one or more servers 502, two or more groups of mobile devices 504 and 506, and one or more wired or wireless networks 512. Each of the mobile devices from both groups is operable to receive a navigation configuration over a network and adopt a navigation model according to the navigation configuration. All of the mobile devices have one or more physical input devices.

In some implementations, the physical input devices on the mobile devices in the first group 504 are distinct from the physical input devices on the mobile devices in the second group 506. In other implementations, the mobile devices in the first group 504 have a set of applications resident on them distinct from a set of applications resident on the second group of mobile devices 506. In further implementations, the mobile devices in the first group 504 belong to users with types of accounts (e.g., business, personal, voice only, voice plus data, and so on) different from users who own mobile devices in the second group 506. For example, mobile devices in the first group 504 can be serviced by a cellular provider that is different from the cellular provider for mobile devices in the second group 506.

The servers 502 are operable to establish navigation configurations 508. The servers establish separate navigation configurations for each group of mobile devices. This is necessary in the case where the mobile devices in the two groups have distinct sets of physical input devices, and useful in the case where the mobile devices in the two groups are otherwise distinguished.

The servers 502 are operable to send separate navigation configurations 508 to their respective mobile devices over a wireless network. The servers are also operable to receive input and configurations from a system operator 510.

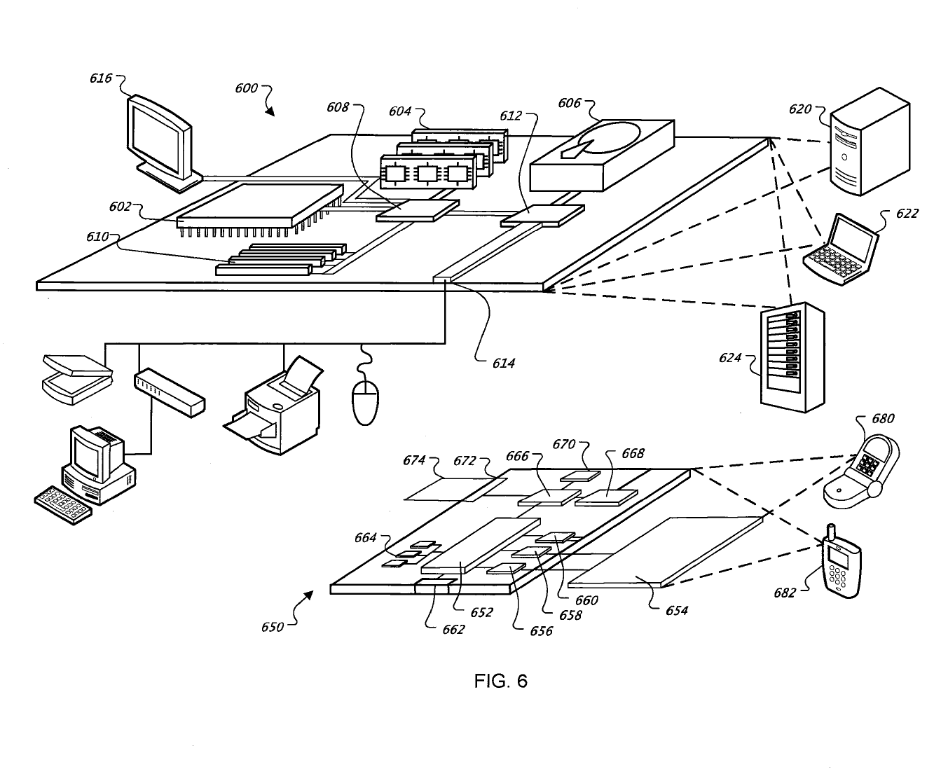

FIG. 6 is a block diagram of computing devices 600 and 650 that can be used to implement the systems and methods described in this document, as either a client or as a server or plurality of servers. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. Such instructions can implement techniques and systems described above, for example. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a computer-readable medium. In one implementation, the memory 604 is a volatile memory unit or units. In another implementation, the memory 604 is a non-volatile memory unit or units. The memory 604 can store user code, such as code associated with the object 106, and supervisor code associated with a virtual machine, such as the client virtual machine 102.

The storage device 606 is capable of providing mass storage for the computing device 600. In one implementation, the storage device 606 is a computer-readable medium. In various different implementations, the storage device 606 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 604, the storage device 606, or memory on processor 602. The storage device 606 can store user code, such as code associated with the object 106, and supervisor code associated with a virtual machine, such as the client virtual machine 102.

The high speed controller 608 manages bandwidth-intensive operations for the computing device 600, while the low speed controller 612 manages lower bandwidth-intensive operations. Such allocation of duties is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can process instructions for execution within the computing device 650, including instructions stored in the memory 664. The processor may also include separate analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD display or an OLED display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication (e.g., via a docking procedure) or for wireless communication (e.g., via Bluetooth or other such technologies).

The memory 664 stores information within the computing device 650. In one implementation, the memory 664 is a computer-readable medium. In one implementation, the memory 664 is a volatile memory unit or units. In another implementation, the memory 664 is a non-volatile memory unit or units. Expansion memory 674 may also be provided and connected to device 650 through expansion interface 672, which may include, for example, a SIMM card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, memory on processor 652, or a propagated signal.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS receiver module 670 may provide additional wireless data to device 650, which may be used as appropriate by applications running on device 650.

Device 650 may also communication audibly using audio codec 660, which may receive spoken information from a user and convert it to usable digital information. Audio codex 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smart phone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

While this specification contains many implementation details, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the invention have been described. Other implementations are within the scope of the following claims. For example, the actions recited in the claims can be performed in a different order and still achieve desirable results.

1. A computer-implemented method comprising:
identifying an initial navigation configuration for a mobile device, the initial navigation configuration specifying a mapping between one or more physical input devices on the mobile device and a plurality of virtual input devices for navigation of a user interface for one or more applications resident on the mobile device;
receiving a new navigation configuration for the mobile device, the new navigation configuration replacing the initial navigation configuration without altering visual appearance of the user interface for the one or more applications resident on the mobile device, the new navigation configuration specifying a mapping between one or more of the plurality of physical input devices on the mobile device and one or more of the plurality of virtual input devices;
receiving input from a first physical input device on the mobile device;
selecting a virtual input device based on the input, the first physical input device, and the new navigation configuration; and
notifying one of the applications on the mobile device based on the input and the selected virtual input device.

2. The method of claim 1 where selecting a virtual input device comprises:
determining whether the new navigation configuration specifies a mapping between the first physical input device and a virtual input device, and if so, selecting the specified virtual input device, and if not, selecting a virtual input device from a default navigation configuration.

3. The method of claim 1 where the new navigation configuration comprises:
a plurality of name and value pairs, where each name specifies a physical input device and a state of the mobile device, and where each value specifies a virtual input device that is mapped to the associated physical input device and state of the mobile device.

4. The method of claim 1 where selecting a virtual input device is further based on a state of the mobile device.

5. The method of claim 4 where the state of the mobile device comprises a screen state and an application mode.

6. A computer-implemented method comprising:
establishing an initial navigation configuration for a mobile device, the initial navigation configuration specifying a mapping between a one or more physical input devices on the mobile device and a plurality of virtual input devices for navigation of a user interface for one or more applications resident on the mobile device;
identifying a plurality of compatible mobile devices, where each of the plurality of compatible mobile devices is operable to receive a navigation configuration and adopt a navigation model according to the navigation configuration without altering visual appearance of the user interface for the one or more applications resident on the mobile device;
sending the initial navigation configuration to each of the identified compatible mobile devices;
establishing a new navigation configuration for the mobile device, the new navigation configuration specifying a mapping between one or more of the plurality of physical input devices on the mobile device and one or more of the plurality of virtual input devices; and
sending the new navigation configuration to one or more of the identified compatible mobile devices.

7. The method of claim 6 where the new navigation configuration comprises:
a plurality of name and value pairs, where each name specifies a physical input device and a state of the mobile device, and where each value specifies a virtual input device that is mapped to the associated physical input device and state of the mobile device.

8. The method of claim 6 further comprising:
receiving from each of the one or more of the identified compatible mobile devices an indication of whether the identified compatible mobile device successfully adopted a new navigation model according to the new navigation configuration.

9. A system comprising a mobile device operable to perform operations comprising:
identifying an initial navigation configuration for the mobile device, the initial navigation configuration specifying a mapping between one or more physical input devices on the mobile device and a plurality of virtual input devices for navigation of a user interface for one or more applications resident on the mobile device;
receiving a new navigation configuration for the mobile device, the new navigation configuration replacing the initial navigation configuration without altering visual appearance of the user interface for the one or more applications resident on the mobile device, the new navigation configuration specifying a mapping between one or more of the plurality of physical input devices on the mobile device and one or more of the plurality of virtual input devices;
receiving input from a first physical input device on the mobile device;
selecting a virtual input device based on the input, the first physical input device, and the new navigation configuration; and
notifying one of the applications on the mobile device based on the input and the selected virtual input device.

10. The system of claim 9 where selecting a virtual input device comprises:
determining whether the new navigation configuration specifies a mapping between the first physical input device and a virtual input device, and if so, selecting the specified virtual input device, and if not, selecting a virtual input device from a default navigation configuration.

11. The system of claim 9 where the new navigation configuration comprises:
a plurality of name and value pairs, where each name specifies a physical input device and a state of the mobile device, and where each value specifies a virtual input device that is mapped to the associated physical input device and state of the mobile device.

12. The system of claim 9 where selecting a virtual input device is further based on a state of the mobile device.

13. The system of claim 12 where the state of the mobile device comprises a screen state and an application mode.

14. A system comprising one or more servers operable to perform operations comprising:
establishing an initial navigation configuration for a mobile device, the initial navigation configuration specifying a mapping between one or more physical input devices on the mobile device and a plurality of virtual input devices for navigation of a user interface for one or more applications resident on the mobile device;
identifying a plurality of compatible mobile devices, where each of the plurality of compatible mobile devices is operable to receive a navigation configuration and adopt a navigation model according to the navigation configuration without altering visual appearance of the user interface for the one or more applications resident on the mobile device;
sending the initial navigation configuration to each of the identified compatible mobile devices;
establishing a new navigation configuration for the mobile device, the new navigation configuration specifying a mapping between one or more of the plurality of physical input devices on the mobile device and one or more of the plurality of virtual input devices; and
sending the new navigation configuration to one or more of the identified compatible mobile devices.

15. The system of claim 14 where the new navigation configuration comprises:
a plurality of name and value pairs, where each name specifies a physical input device and a state of the mobile device, and where each value specifies a virtual input device that is mapped to the associated physical input device and state of the mobile device.

16. The system of claim 14 where the system is further operable to perform operations comprising:
receiving from each of the one or more of the identified compatible mobile devices an indication of whether the identified compatible mobile device successfully adopted a new navigation model according to the new navigation configuration.

17. A system comprising one or more servers operable to perform operations comprising:
establishing a first navigation configuration for a first group of mobile devices having a first plurality of physical input devices, wherein:
the first navigation configuration specifies a mapping between the first plurality of physical input devices and a first plurality of virtual input devices for navigation of a first user interface; and
each of the first group of mobile devices is operable to receive the first navigation configuration and adopt a first navigation model according to the first navigation configuration without altering visual appearance of the first user interface;
establishing a second navigation configuration for a second group of mobile devices having a second plurality of physical input devices, the second group of mobile devices being distinct from the first group of mobile devices, wherein:
the second navigation configuration specifies a mapping between the second plurality of physical input devices and a second plurality of virtual input devices for navigation of a second user interface; and
each of the second group of mobile devices is operable to receive the second navigation configuration and adopt a second navigation model according to the second navigation configuration without altering visual appearance of the second user interface;
sending the first navigation configuration to the first group of mobile devices and the second navigation configuration to the second group of mobile devices.

18. The system of claim 17 further comprising:
the first and second groups of mobile devices.

19. The system of claim 17 where each of the first and second navigation configurations comprises:
a plurality of name and value pairs, where each name specifies a physical input device and a state of the mobile device, and where each value specifies a virtual input device that is mapped to the associated physical input device and state of the mobile device.

20. A computer program product, encoded on a non-transitory computer-readable medium, operable to cause data processing apparatus to perform operations comprising:
identifying an initial navigation configuration for a mobile device, the initial navigation configuration specifying a mapping between one or more physical input devices on the mobile device and a plurality of virtual input devices for navigation of a user interface for one or more applications resident on the mobile device;
receiving a new navigation configuration for the mobile device, the new navigation configuration replacing the initial navigation configuration without altering visual appearance of the user interface for the one or more applications resident on the mobile device, the new navigation configuration specifying a mapping between one or more of the plurality of physical input devices on the mobile device and one or more of the plurality of virtual input devices;
receiving input from a first physical input device on the mobile device;
selecting a virtual input device based on the input, the first physical input device, and the new navigation configuration; and
notifying one of the applications on the mobile device based on the input and the selected virtual input device.

21. The computer program product of claim 20 where selecting a virtual input device comprises:
determining whether the new navigation configuration specifies a mapping between the first physical input device and a virtual input device, and if so, selecting the specified virtual input device, and if not, selecting a virtual input device from a default navigation configuration.

22. The computer program product of claim 20 where the new navigation configuration comprises:
a plurality of name and value pairs, where each name specifies a physical input device and a state of the mobile device, and where each value specifies a virtual input device that is mapped to the associated physical input device and state of the mobile device.

23. The computer program product of claim 20 where selecting a virtual input device is further based on a state of the mobile device.

24. The computer program product of claim 20 where the state of the mobile device comprises a screen state and an application mode.

25. A computer program product, encoded on a non-transitory computer-readable medium, operable to cause data processing apparatus to perform operations comprising:
establishing an initial navigation configuration for a mobile device, the initial navigation configuration specifying a mapping between a one or more physical input devices on the mobile device and a plurality of virtual input devices for navigation of a user interface for one or more applications resident on the mobile device;
identifying a plurality of compatible mobile devices, where each of the plurality of compatible mobile devices is operable to receive a navigation configuration and adopt a navigation model according to the navigation configuration without altering visual appearance of the user interface for the one or more applications resident on the mobile device;
sending the initial navigation configuration to each of the identified compatible mobile devices;
establishing a new navigation configuration for the mobile device, the new navigation configuration specifying a mapping between one or more of the plurality of physical input devices on the mobile device and one or more of the plurality of virtual input devices; and
sending the new navigation configuration to one or more of the identified compatible mobile devices.

26. The computer program product of claim 25 where the new navigation configuration comprises:
a plurality of name and value pairs, where each name specifies a physical input device and a state of the mobile device, and where each value specifies a virtual input device that is mapped to the associated physical input device and state of the mobile device.

27. The computer program product of claim 25 where the operations further comprise:
receiving from each of the one or more of the identified compatible mobile devices an indication of whether the identified compatible mobile device successfully adopted a new navigation model according to the new navigation configuration.
